(19) United States
(12) Patent Application Publication
(10) Pub. No.: US 2004/0260812 A1
(43) Pub. Date: Dec. 23, 2004

(54) Ethernet-based fire system network

(76) Inventors: Neil Rhodes, Evanston, IL (US); Tom Rule, Arlington Heights, IL (US)

Correspondence Address: Siemens Corporation, Intellectual Property Department, 170 Wood Avenue South, Iselin, NJ, 08830, US

(21) Appl. No.: 10/671,234

(22) Filed: Sep. 25, 2003

Related U.S. Application Data
(63) Continuation-in-part of application No. 10/601,129, filed on Jun. 20, 2003.

(51) Int. Cl. G06F 15/173

(52) U.S. Cl. 709/225; 709/229

(57) ABSTRACT

A data transmission system for a building or facility includes a fire control sub-network, a building automation sub-network and/or a corporate sub-network. The fire control sub-network includes workstations connected to fire control panels that are connected to fire control devices. The sub-network includes an Ethernet switch that is UL listed for fire protective signaling uses, along with the workstations. This sub-network is integrated with the building automation sub-network through an IP router that is UL listed for information technology equipment. Thus, the fire control sub-network is both electrically isolated and isolated from data transmission traffic through the building automation and/or corporate sub-networks, so that the response of the fire control sub-network is not compromised by data traffic through the other networks. In certain embodiments, building automation workstations and control devices can be included within the fire control sub-network.

This application claims the benefit of priority to co-pending U.S. patent application Ser. No. 10/601,129, having the same title as the present application, and which was filed Jun. 20, 2003, in the name of the same inventors.

### FIELD OF THE INVENTION

The present invention relates to fire safety systems and more specifically to fire safety systems that are configured for use with building control systems of the type that control heating, ventilation, air conditioning, lighting, security and other sub-systems of a building or facility.

### BACKGROUND OF THE INVENTION

Nearly every commercial building and most private residences have some form of fire safety system, ranging from a simple smoke detector to a comprehensive fire safety system network. Typically, commercial buildings, factories and building campuses include elaborate systems that employ a plurality of detection devices to warn of a possible fire, notification appliances to send an alert or evacuation signal, automatic fire suppression and/or smoke control devices, and building control devices that manipulate building components such as doors, ventilation devices, elevators and the like.

Complex control systems are also used to control the building functions, such as HVAC, water management and the like. Unlike these building control systems, the hope is that the fire safety system is never needed. Nevertheless, when a fire occurs, a properly engineered fire control system can protect lives and property. Of course, early detection capabilities, such as through smoke, heat and/or flame detectors, go a long way toward minimizing the risks of a fire. Many commercial building fire safety systems can automatically send an alarm to a nearby fire station. More sophisticated systems can integrate with building functions to help contain, and in some cases, disperse a fire. For instance, fire doors may be closed to isolate a fire, HVAC can be commanded to stop supplying air to help starve the fire, and overhead sprinklers can be automatically activated to quench the fire. In addition, certain building controls can activate dedicated fans to pressurize stairwells and elevator shafts to keep smoke from spreading to these ingress and egress paths. The efficacy of these responses requires prompt notification of the emergency condition, such as by transmission of an alarm throughout the facility data transmission network.

Fire safety systems are potentially the most important system installed in a new construction. Consequently, many government and/or industry regulations dictate functionality and standards of operations of such systems. Of course, most fire control/alarm systems meet or exceed these standards.

Many if not most large fire safety systems include at least one supervisory computer workstation that allows a system operator to oversee the fire network. The various devices of the fire safety network communicate signals with the work station via a data network. The use of supervisory control workstations allows for large facilities to satisfy fire system monitoring requirements and notification requirements with less human intervention than would otherwise be needed. There are strict industry/government requirements to these workstations if they are to provide the needed fire system functions. They must be UL-certified fire protective signaling devices. To further improve flexibility and control, most sophisticated fire safety systems employ multiple control workstations from which aspects of the entire system may be monitored and controlled.

Using the workstations, the operator can also issue commands to the system to configure various functions. The fire safety devices can also send information to the operator. For instance, the fire safety system can periodically perform a self-check to verify that the fire alarm and control devices will function properly in the event of an emergency. This self-check information is fed back to the operator through the user interface. If the information is not received, or if a trouble signal is transmitted, the operator is alerted to examine the fire safety system component.

These functions occur on a periodic basis and are generally geared toward ensuring the operability of the fire safety system. Other functions occur at the operator end of the system, such as record keeping, review of historical data, scheduling maintenance, etc. While most of these functions are not time critical, the issuance of a fire alarm by the fire safety system is. It is here where the responsiveness of the system is of paramount importance. Delays of any type can be dangerous to life and property. Consequently, it is important that any efforts to network a fire safety system with other systems do not create any delays in the processing of emergency information generated by the system.

In particular, when multiple networked workstations are used as industry qualified fire protective signaling devices, certain regulations require that fire alarm messages be communicated to all such devices within a certain time frame. Because large integrated computer networks such as corporate Ethernets and the like have too many computers performing too many unpredictable functions, fire workstations cannot simply be connected to any Ethernet hub in a corporate network.

To meet industry standards, prior art systems have provided dedicated networks containing only fire system devices, or have used deterministic network models such as token ring networks. A token ring network typically can provide a more predictable message transmission time. However, token ring networks are not convenient or cost effective. Similarly, the use of any isolated network exclusively for communication between fire workstations is typically costly, and does not facilitate ease of integrations of fire safety system operations and other non-fire building control operations.

There is a need, therefore, for an integrated fire safety system network that decreases the inefficiencies arising from the specific requirements of fire signaling equipment and allows for greater integration with other building control system operations.

### SUMMARY OF THE INVENTION

The present invention fulfills the above need, as well as others, by integrating both fire control workstations and non-fire building control workstations on the same network, preferably an Ethernet or similar network. By carefully controlling the number of devices on the network, alarm messages may be communicated in accordance with industry standards even in a non-deterministic network such as Ethernet. Moreover, in one embodiment, other non-fire building control workstations may be connected to a non-controlled general corporate network. In such a case, an IP router is used to connect the corporate Ethernet to the fire Ethernet. The IP router only allows communications between building control workstations (Fire and non-fire), thereby ensuring that general corporate Ethernet traffic does not impede alarm messages. By carefully controlling the number of building control system workstations (and the messages they create) on both sides of the router, the required alarm message transmission rate may be maintained on the fire network.

In broad terms, the present invention contemplates a data transmission system for a facility comprising a first network having a number of operationally critical devices disposed within the facility, and at least one first computer workstation operably coupled to the number of critical devices via the first network. In the preferred embodiment of the invention, these critical devices are fire safety devices, such as fire control panels and associated fire control devices. By the designation “critical” it is meant that the integrity and operation of these devices cannot be interrupted or compromised because they form essential components of a life and property safety system. In prior systems, these critical devices can be conflicted by data transmissions from sources outside the fire control network, or at a minimum can have their response speeds compromised or delayed by non-critical data transmissions outside the fire control network.

These non-critical data transmissions can be generated within a second network that includes at least one second computer workstation. In accordance with the present invention, this second network can be either or both of a corporate network capable of broadcast transmissions, or a building automation network. The building automation network includes a number of workstations that provide communication and control for a number of building control devices, such as HVAC controllers. The workstations within the building automation network transmit data amongst themselves and can also transmit data to the corporate network.

In prior systems, the fire control network is maintained in absolute isolation from these other networks, thereby eliminating any compromise or data transmission problems. However, this absolute isolation severely limits the functionality of the fire control network. For instance, an isolated fire control network cannot transmit alarm signals to workstations in the corporate or building control networks. Moreover, any communication, command and control of the fire control devices cannot be performed by any workstations outside the fire control network.

In order to integrate the fire control network with one or both of the other networks, the present invention contemplates the provision of an isolating router coupling the first fire control network to the second network. This router is operable to isolate the fire control network from data transmission traffic in the second network. In a preferred embodiment, the workstations of the fire control network are assigned MAC (media access control) and IP addresses that are used by the isolating router to block unwanted data transmissions to the fire control network. With this feature, data communication within the fire control network will not be bogged down by non-critical data transmissions and/or the communication bandwidth will not be diminished within that network.

The fire control network includes a first Ethernet switch that is UL listed for fire protective signaling uses and that is operable to electrically isolate the first network from the isolating router. The workstations and other components within the fire control network may also be listed under the same UL standard. One consequence of this UL listing is that at listed devices, most particularly the Ethernet switch, include their own power supplies, such as a battery backup, so that the fire control network continues to work when building power has been interrupted.

On the other hand, in one aspect of the invention, the isolating router between the fire control network and the other networks need not be listed for fire protective signaling uses. Instead, the isolating router must be UL listed as information technology equipment. With this UL listing, the isolating router does not require its own power source, since a loss of power to the isolating router does not compromise the emergency performance of the fire control network.

Where the second network is a building automation network, a second Ethernet switch can be provided that is operably coupled to a number of building control devices. These building control devices are independent of the operationally critical devices (i.e., the fire control devices). This second Ethernet switch need not adhere to either UL listing requirement for purposes of the present invention because no operationally critical devices (such as fire control devices) are connected to that switch.

In certain embodiments of the invention, components of the building automation network can be incorporated into the fire control network. In this circumstance, a building automation workstation and associated building control devices communicate with the other devices of the fire control network through the first Ethernet switch. Since this communication occurs through the UL listed Ethernet switch, the building automation workstation does not need to be a PC UL listed for fire protective signaling uses.

The building automation workstations are configured to execute building control software. In one embodiment, this building control software utilizes a database server/client system, meaning that a database workstation operates as a server for a number of client workstations, with each client workstation communicating with associated building control devices. In a further aspect of the invention, the database server must be incorporated into the fire control network so that the server is isolated through the fire control network first Ethernet switch and through the isolating router.

In some cases, the second network includes a corporate network, independent of the building control network and of the fire control network. One enhancement offered by the present invention is the ability to link the fire control network to the corporate network so that information can be passed between the two networks. However, the typical corporate network, includes a plurality of workstations that transmit “non-critical” information. In prior systems, this non-critical information is transmitted through the networks, including the fire control network, which slows the data performance of all networks. Moreover, many of the corporate network workstations are capable of broadcast transmissions which can significantly diminish the available bandwidth of all the networks. In this instance, the present invention contemplates that the isolating router is operable to block these non-critical and broadcast transmissions to the first fire control network.

In another feature of the invention, a data transmission system is provided for use in a facility. The system can comprise a first fire control Ethernet sub-network including a number of fire control devices and a number of fire safety workstations operably coupled to the fire control devices and operable to implement software for maintaining and controlling the fire control devices. The system can also include a second building control Ethernet sub-network including a number of building control devices and a number of building automation workstations operably coupled to the building control devices and operable to implement software for maintaining and controlling the building control devices. In an important feature of the present invention, an isolating router connects the first sub-network to the second sub-network and is operable to isolate the first sub-network from data transmission traffic in the second sub-network. The need for the isolating router arises in the first instance because non-UL listed components can communicate with UL fire listed devices.

The building automation workstations can include a database server workstation and at least one database client workstation. In certain embodiments of the invention, the database server workstation is connected within the first sub-network. In a further aspect of the invention, all of and only the workstations connected within the first sub-network are UL listed for fire protective signaling uses. Moreover, the first sub-network includes a first Ethernet switch that is UL listed for fire protective signaling uses. On the other hand, the isolating router is UL listed for information technology equipment.

One benefit of the present invention is that it permits integration of a fire control network with a building automation network without compromising the critical performance of the fire control network. Another benefit is that the invention provides means for data, command and control to be shared between the fire control network and other “non-critical” networks, such as building automation or corporate networks.

Other benefits and certain objects of the invention will become apparent upon consideration of the following written description considered together with the accompanying figures.

### DESCRIPTION OF THE FIGURES

FIG. 1 is a schematic representation of a fire safety system network that can be integrated using the present invention.

FIG. 2 is a schematic representation of a building automation network that can be integrated with the fire safety system network shown in FIG. 1 with the present invention.

FIG. 3 is a schematic representation of an illustrative example of the second embodiment of the invention.

FIG. 4 is a schematic representation of the integration of fire safety system networks in different buildings in accordance with a further embodiment of the present invention.

FIG. 5 is a schematic representation of a first embodiment of the invention;

FIG. 6 is a schematic representation of a second embodiment of the invention.

### DESCRIPTION OF THE PREFERRED EMBODIMENTS

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains.

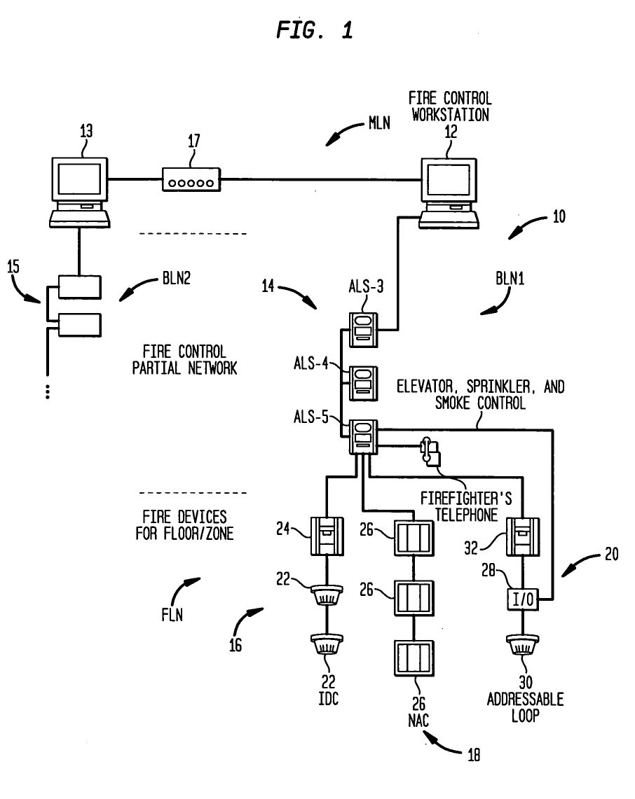

The present invention contemplates the integration of a fire safety system network into a building control network, and even into a larger network that incorporates functions beyond building control and fire safety. A typical fire safety system network is shown in FIG. 1. The network 10 in the embodiment described herein actually involves several layers of interconnected subnetworks, including a management level network MLN, one or more building level network BLN1, BLN2, and one or more floor level networks associated with each building level network. For example, floor level networks 16, 18 and 20 are associated with the BLN1 of FIG. 1.

The MLN, which preferably includes an Ethernet standard network employing TCP/IP protocol, includes a plurality of workstations, represented herein as workstations 12 and 13, connected via a switch 17, that provide a graphical and/or text-based user interface for the fire safety system. Each of the workstations 12, 13 is also connected to a set of fire safety devices via a lower level BLN. The workstations 12, 13 employ the MLN to share data received from such devices.

In accordance with good building engineering practices, the workstations 12, 13 are PCs that are UL (Underwriter's Laboratories) listed for fire protective signaling use. The UL listing indicates that the component has been tested to meet a particular standard. In the case of fire control and alarm systems, the industry accepted standard is published by the National Fire Prevention Association (NFPA) and takes into account various government standards applicable to fire safety. The NFPA publishes the National Fire Alarm Code (NFPA 72), the Life Safety Code (NFPA 101), Recommended Practices for Smoke-Control System (NFPA 92A) and other related standards. All of these standards are recognized as an American National Standard for the engineering, installation and maintenance of fire safety systems for buildings/facilities of all types. All fire alarm/control systems should utilize only components that are UL certified for use in fire protective signaling.

In further detail of the fire safety devices, the workstation 12 is connected to a first building level network BLN1 that facilitates communication with and among a number of fire control panels 14 that monitor and control various fire devices and functions. These fire control panels are also UL listed for fire protective signaling use. These panels 14 are specialized hardware devices that connect to networks of fire detection and notification devices, as well as providing other fire control functions. One such fire control panel is the ALS-3 panel produced and sold by Siemens Building Technologies, Inc. In general, the ALS-3 fire control panel includes a central processor, battery back-up, a network interface card, connections for a number of fire device networks, connections for a firefighter's phone system, dry contacts for additional functions, and a user interface including status indicators. The network interface card for each of the fire control panels 14 allows communication among all of the panels 14 and with the fire control workstation 12.

The workstation 12 can be regarded as residing at a management level of the fire safety system 10. The fire control panels 14 form part of the BLN1. As shown in FIG. 1, at least one of the of the fire control panels 14 is further connected to a plurality of floor level or device networks 16, 18 and 20 that include the fire control devices themselves. Each type of device is preferably connected to a common fire control panel that monitors the associated device network for trouble, receives signals from and sends signals to the device network, and usually provides power to the devices on the network. The associated fire control panel 14 also includes means to test the integrity of the device network 16, 18, 20, and connected fire control devices and to produce a trouble signal, in the event of a malfunction or anomaly, that is communicated to the management level fire control workstation 12.

The workstation 13 is similarly connected to a building level network BLN2 to which is connected a number of fire control panels 15. The fire control panels 15 are typically each connected to floor level networks, not shown, but which are similar to networks 16, 18, 20.

The device networks accommodate different fire control devices. For instance, network 16 includes Initiating Device Circuits (IDCs), which can include smoke detectors 22 and pull switches 24. The device network 18 includes Notification Appliance Circuits (NACs) 26 that are similar to IDCs but include a notification device, such as horns, strobes or speakers. The fire control panels 14 associated with each of these networks continuously monitors the integrity of these networks 16, 18 by passing a low level current through the circuits of the IDCs 22, 24 and the NACs 26. Any disruption in this continuous current (that is not associated with an alarm condition) is identified by the fire control panel as an error condition giving rise to a trouble signal.

The device network 20 can be an Addressable Loop 28, which is a network of addressed devices so that the fire control panel can selectively receive and transmit signals from detection devices on the loop. As shown in the example of FIG. 1, the addressable loop 28 includes an IDC smoke detector 30 and a pull switch 32. Unlike the device networks 16 and 18, the addressable loop 28 of the network 20 does not use a continuous signal to monitor its integrity. Since all of the devices on the loop 28 are assigned an address, the fire control panel can routinely communicate with these devices to see if they are still available. A failure to communicate with a particular addressed device causes the control panel 14 to generate a trouble signal that is supplied to the management level workstation 12.

Prior fire control systems, such as the system 10, are usually “stand-alone” systems, meaning that the workstations 12, 13 and networks, including the management level network MLN, are independent of any other networks associated with the particular building or campus. A primary reason for this isolation is that the components of the fire control system 10 must be UL listed for fire protective signaling in order to meet most local and national building codes. Moreover, there are limitations as to the time it takes certain messages to propagate to the various workstations, e.g. workstations 12, 13.

As will be discussed below, one aspect of the invention is to integrate fire safety systems and building control systems on a single network. To this end, the building control system (e.g. HVAC, security, lighting systems or the like) is carefully integrated to ensure that fire alarm notification to all designated fire control workstations occurs within the limits of certification standard UL864. To this end, the system is designed to balance the data speed capacity of the MLN with the management level network messages generated by both fire and non-fire building control workstations to ensure that the network MLN is always capable of providing fire alarm messages within the allotted time limits.

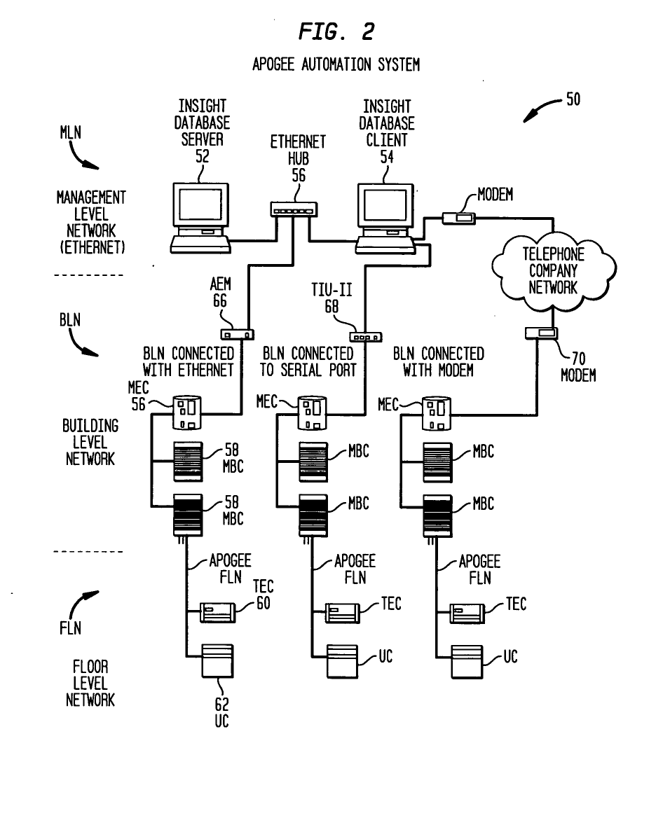

Another aspect of the invention carries the concept further. This further aspect provides a system for integrating a fire control system, such as the system 10, into a building automation and control network, such as the network 50 shown in FIG. 2, such that at least a portion of the building automation and control system could be disposed on a second network that is shared by ordinary corporate workstations unrelated to building control systems. Because the second network contains non-building control workstations, the speed with which messages are transferred cannot be guaranteed as required by UL 864. To address this issue, the present invention ensures that only the fire control network include fire control workstations, although both networks may include non-fire building control workstations. As such, the building automation and control systems would be able to take advantage of existing Ethernet (or other corporate network) facilities while also taking advantage of the fire control network to create a cost-efficient, integrated building control solution.

The building automation network 50 depicted schematically in FIG. 2 can be the APOGEE Automation System, produced and sold by Siemens Building Technologies, Inc. The APOGEE Automation System provides building control hardware and software that enables management and maintenance of environmental control equipment in a building/facility. Typically, the APOGEE system controls the overall building environment by managing one or more air handlers that supply heated or cooled air to the building. Local equipment controllers manage conditions in different parts of the building by controlling the flow of air to those areas and by providing additional heating and cooling as needed. Equipment controllers can also perform specialized functions such as managing a boiler or chiller, controlling a laboratory fume hood or monitoring air pressure in clean rooms.

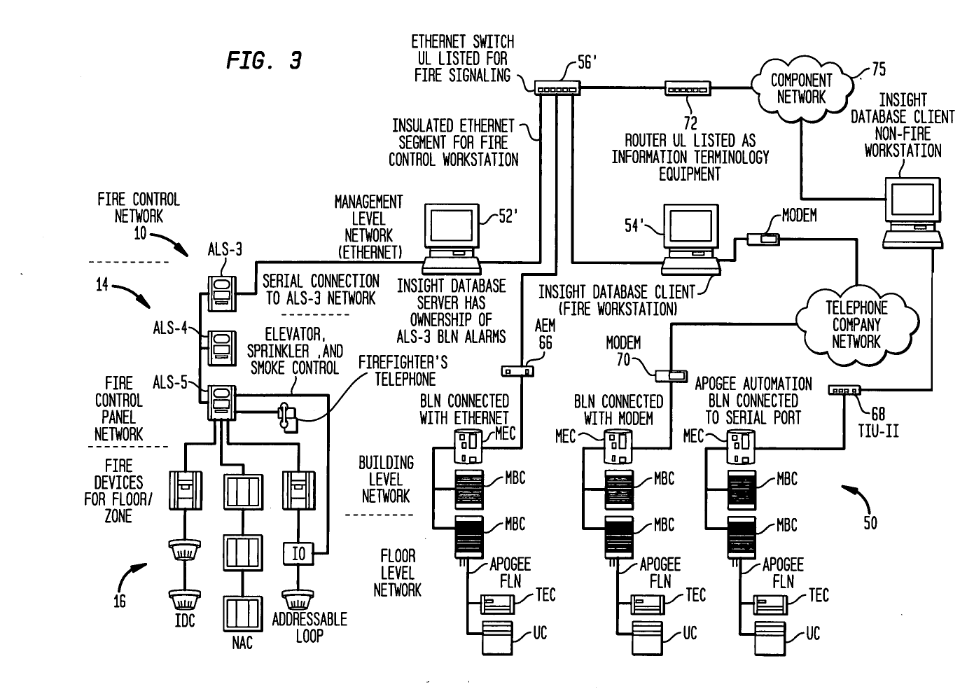

As shown in FIG. 2, the management level network includes a number of workstations 52, 54 that implement building automation software, such as the INSIGHT software system offered by Siemens Building Technologies, Inc. for use with the APOGEE system. This software allows an operator at each workstation 52 to acknowledge alarms, monitor and command points, configure the system, program field panels, schedule equipment, run reports and collect historical data. In accordance with a preferred embodiment of the automation system 50, the workstation 52 serves as a database server for a number of client workstations 54. The client workstations 54 are preferably connected to the server workstation 52 through an Ethernet switch 56, forming the management level network MLN. This management level network MLN can be a stand-alone network. Alternatively, the management level network MLN can be part of an existing corporate Ethernet network 75 (FIG. 3), which embodies management, financial and e-mail communications.

As shown in FIG. 2, the building automation system 50 includes various field panels 56, 58 at the building level network BLN. These field panels can include mechanical equipment controllers (MECs) 56, modular equipment controllers (MBCs) 58, as well as stand alone controllers (SCUs) and floor level network controllers (FLN Cs) not depicted in FIG. 2. These field panels 56, 58, communicate with equipment controllers at the floor level network FLN. Several equipment controllers are typically installed on each floor or in each discrete area of a building. These can include terminal equipment controllers (TECs) 60 and unitary controllers (UCs) 62. With the APOGEE system, up to 32 controllers 60, 62 can be connected to a single field panel 56, 58. Each field panel communicates with its associated equipment controllers by routinely polling each controller for information and by sending commands to the controllers when necessary.

As shown in FIG. 2, each BLN controller 56, 58 can communicate to a client workstation 54 in several ways. For instance, the connection can be directly to the Ethernet switch 56 by way of an Ethernet micro-server 66, to a serial port of the workstation by way of a trunk interface 68, or by dial-up through a modem 70.

As explained above, since these components of the building automation network 50 are not used for fire control, there is no need for the components to carry a UL listing for fire protective signaling use. The present invention contemplates a system that allows integration of the fire control network 10 of FIG. 1 with the building automation network 50 of FIG. 2, as well with any corporate network 75 that may exist. It is important that this integration not affect or compromise the configuration and operation of the fire control network 10. It is also important that this integration maintain the use of UL certified equipment within the fire control network, as described above.

Essentially, as discussed above, one aspect of the present invention is a dedicated fire control network that can include building control system devices. By dedicated, it is meant that the MLN network is especially configured such that all fire notification messages are communicated to all workstations on the MLN within the minimum time required by UL 384. To this end, a limited amount of workstations provide a controlled amount of traffic on the MLN. This may be controlled by providing only building system control workstations on the MLN. Because the amount of message traffic generated by a building control workstation can be limited with certainty to a predictable safe harbor, a dedicated network can be built using and Ethernet or other non-deterministic network and still definitively satisfy the minimum alarm notification requirements. Those of ordinary skill in the art may readily determine, through empirical and/or theoretical methods, how many building control workstations may be on a dedicated Ethernet network of a certain size and still guarantee that messages generated by a connected fire safety system will reach all entities on the Ethernet network within a certain amount of time.

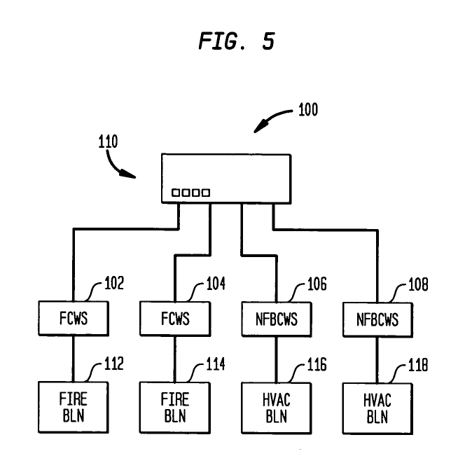

FIG. 5 shows a first example of such a network 100. The network 100 includes four workstations 102, 104, 106 and 108 connected by an MLN 110. The first workstation 102 is connected to a fire control BLN 112 (see e.g. FIG. 1) and therefore is a fire control workstation. The second workstation 104 is also connected to a fire control BLN 114 and therefore is also a fire control workstation. The third workstation 106 is connected to a non-fire building control BLN 116 (see e.g. FIG. 2) and therefore is a non-fire building control workstation. The fourth workstation 108 is also connected to a non-fire control BLN 118 and therefore is also a non-fire building control workstation.

As discussed above, any fire alarm messages generated by devices on the BLNs 112 and 114 will be communicated through the entire network 100, including the management level network 110, such that all fire control workstations, such as workstations 102 and 104, receive the message in the maximum time allotted by UL 864. A fire control workstation includes a workstation operating as a fire control database server, a workstation connected to a fire control BLN, or a workstation that is used as a primary annunciator (i.e., manned by an operator as a primary means of monitoring the fire system). The workstations 106 and 108 need not constitute fire notification workstations and consequently do not need to be UL listed devices.

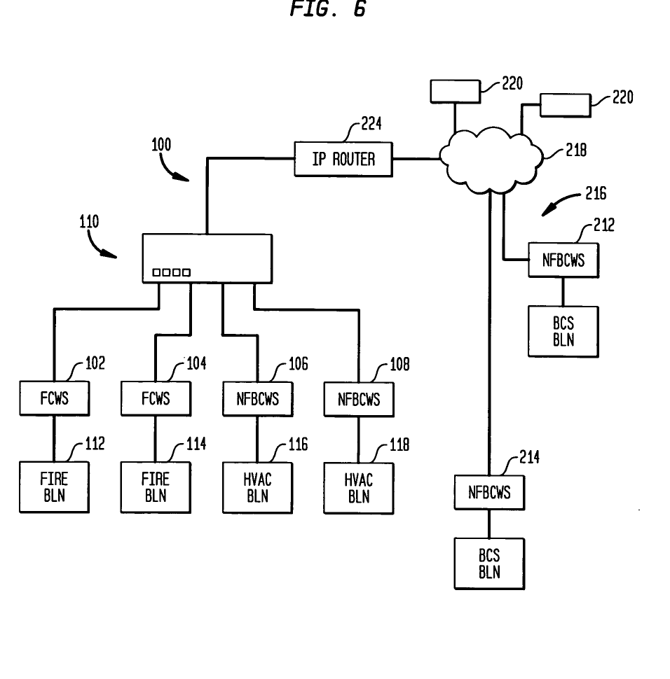

FIG. 6 shows another aspect of the invention in which at least some non-fire building control workstations 212 and 214 are located on a second network 216 that includes a corporate network 218 to which non-building control workstations 220, 222 are connected. The non-fire building control workstations 212 and 214 may or may not be connected to BLNs of non-fire building systems, such as HVAC, security, lighting, automation controls, or other building control systems.

A router 224 connects the second network 216 with the fire control network 100. The router 224 allows messages from the second network 216 to communicate with the building control workstations 102, 104, 106 and 108 of the fire control network 100 only if those messages are provided by the building control system workstations 212, 214. Messages from other non-building control workstations (e.g. workstation 220, 222) cannot propagate through the router 224. To this end, the router 224 is preferably UL listed as information technology equipment.

Carefully allowing only building control workstation messages to propagate from the second network 216 to the network 100 allows the system to be set up in such a way as to ensure that the MLN 110 has sufficient available bandwidth to ensure that fire alarm messages are received by all of the workstations 102, 104, 106 and 108 in the time dictated by UL standards (or a faster time limit specified internally).

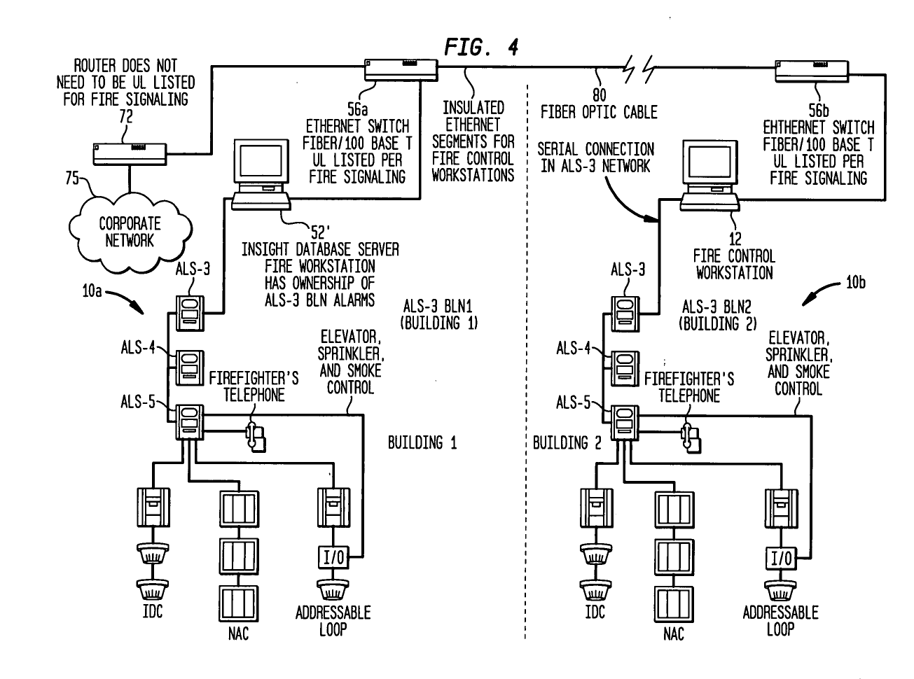

FIGS. 3 and 4 show some more specific illustrations of the concepts of the invention. FIG. 3 shows a more detailed example of the system shown generally in FIG. 6 in which the non-fire building control workstations are located on both a fire control isolated network similar to network 100, and a second network that incorporates non-building control workstations similar to the network 216. In particular, FIG. 3 shows one embodiment in which the fire control network of FIG. 1 is integrated with a building automation network 50 of FIG. 2 and with a corporate network 75.

As shown in FIG. 3, the fire control network 10 includes both a fire control workstation 52′ and non-fire control workstations 66, 54′. The fire control network further includes an Ethernet switch 56′, which can be similar to the switch 56 shown in FIG. 2 but configured as a UL listed hub for fire protective signaling uses. Thus, the switch 56′ may suitably be the same as the switch 17 of FIG. 1. Certain components of the building automation system 50 may also be connected to the UL listed Ethernet switch 56′; however, direct connection to the switch 56′ is permitted in limited circumstances. For instance, certain building level network BLN devices are connected through the micro-server 66 to the switch 56′. Other BLN devices fed through the modem 70 must communicate with a building automation client workstation 54′ that is similar to the workstation 54 described with respect to FIG. 2.

The Ethernet Switch 56′ is UL listed for fire signaling devices, which means that it must electrically isolate all devices (52′, 66, 54′) connected to it. This isolation capability allows connection non-UL listed equipment to the switch, since electrical failure in such equipment cannot be communicated to other devices linked through the switch 56′. The UL-listed switch must include a battery back-up. The workstation 54′, although principally used for communication with building control devices within the building automation system 50, may also be a UL certified PC if it includes software capable of monitoring and commanding the fire alarm networks 14 at the BLN (see FIG. 1). However, the workstations 54′ preferably are not permitted to configure the fire alarm networks, but only to monitor the fire system. In this case, the workstations 54′ need not be UL-fire certified.

In a further aspect of the invention, the database server workstation 52′ for the building automation system 50 is similar to the workstation 52 of FIG. 2, but must be a UL fire listed PC. Moreover, this management level (MLN) server workstation 52′ has ownership of the fire alarm networks 14 at the BLN and is dedicated to the fire alarm side of an IP router 72.

An important feature of the invention is that the Ethernet network containing the fire system workstations and devices is isolated from non-critical data transmissions from non-fire related components. Thus, the invention contemplates the use of an IP router 72 between the dedicated fire-control Ethernet network (which contains all of the fire-related devices and some non-fire related building control devices) and a corporate network 75 (which can contain non-fire related building control devices and non-building control/non-fire related devices).

In the illustrated embodiment, the building automation components 50 are fed through a trunk interface 68 to a non-fire related workstation 71. This workstation 71 can be connected to the corporate network 75.

The router 72 is configured to permit controlled communication between the corporate network 75 the “fire side” components, such as the workstations 52′ and 54′. Thus, each device connected to the “fire side” Ethernet is assigned a MAC address which is used by the IP router 72 to isolate traffic between the corporate and the “fire side” networks/sub-networks. The router will block all traffic from one Ethernet to the other unless it knows it is destined for a specific device on that network. With this limitation, broadcasts to “all devices” do not pass through the router.

The present invention contemplates integrating a fire control network, such as the network 10 shown in FIG. 1, into a larger network that can include a building automation network, such as network 50 shown in FIG. 2, and/or a corporate network, such as network 75 shown in FIG. 3. This integration is accomplished to meet the UL listing requirement for fire protective signaling uses by isolating any segment connected to a fire workstation from the rest of the network. This isolation is accomplished in the first instance by an IP router, such as router 72 in FIG. 3 that does not need to be UL fire-listed but must be UL listed for information technology equipment.

Certain components of the building automation system 50 are also connected to the UL listed Ethernet switch 56′, such as the building level network BLN devices connected through the micro-server 66 and the BLN devices fed through the modem 70. The switch 56′ is UL fire listed, and thus includes its own power source, and also provides electrical isolation. As a consequence of the electrical isolation, other non-UL listed (i.e. non-fire notification) workstations may be connected to the isolated fire control network 10.

The modem 70 communicates with a building automation client workstation 54′ that is similar to the workstation 54 described with respect to FIG. 2. However, in this embodiment, the workstation 54′ is UL listed for fire protective signaling uses. Thus, the workstation 54′, although principally used for communication with -building control devices within the building automation system 50, must also be a UL certified PC. This workstation 54′ can include software capable of monitoring and commanding the fire safety system networks 14 at the BLN (see FIG. 1). The benefit of certifying the workstation 54′ for fire protective signaling use will depend on the need for fire protective signaling workstations. If the workstation 52′ is sufficient for fire protective signaling, then the workstation 54′ need not be UL certified for fire protective signaling.

The fire control workstation 52′ is similar to the workstation 52 of FIG. 2, but must be a UL fire listed PC. Moreover, this management level (MLN) server workstation 52′ has ownership of the fire safety system networks 14 at the BLN.

An important feature of the invention is that the fire control workstations, networks and devices are isolated from non-critical data transmissions from non-fire related components. Thus, the invention contemplates the use of an IP router 72 between the network 10 and the corporate network 75. In the illustrated embodiment, the router 72 is connected to the building automation components fed through the trunk interface 68. In addition, the corporate network 75 is connected to the router 72. The router is configured to permit controlled communication between the “fire side” components, such as the workstations 52′ and 54′, and the corporate network 75. In this way, workstations within the corporate network have access to data generated by the fire control workstation 52′, as well as the building control workstations 54′. Since the router is not integrated into the fire control system 10, it need not be UL listed for fire protective signaling uses. Instead, the router 72 must be UL listed for information technology equipment (ITE).

In accordance with a preferred embodiment of the invention, each fire control panel (the ALS-3 panels) is connected to an associated workstation via the serial data port of the PC. Each UL fire-listed PC workstation can be connected to a maximum of four ALS-3 fire safety system networks.

In a specific embodiment, each BLN can contain a maximum of 64 fire control panels (ALS-3 panel), with each panel addressed with a node number from 1 to 64. These node numbers can be used to identify each associated fire control panel throughout the building automation network as well as through the corporate network. In addition, each PC workstation on the either side of the IP router 72 is typically assigned a MAC (medium access control) address. This MAC sublayer controls transmission access to the identified medium within each Ethernet, but not across the router 72. The router 72 passes information between the corporate network 75 and the network 10 using IP addresses. The router 72 can thus control transmission access to the fire control workstations and network 10 so that the fire control network 10 is always free to transmit emergency information to the fire control workstation 52′. In other words, the presence of the router 72 creates a subnet on which the fire control system 10 resides which is isolated from the non-critical network functions and communications, such as corporate e-mail, customer database transmissions, and which is isolated from community devices such as document servers and employee PCs. In this way, no non-critical workstation is able to issue a transmission that will interfere with any transmissions within the fire control system 10 and BLN fire control panels 14. The router 72 can also control any broadcast transmissions to again isolate the fire control system 10.

All switches on the Ethernet on the network 10 that are connected to UL listed fire protective signaling (i.e. workstations 52′ and 54′) must themselves be UL fire-listed, such as the Ethernet switch 56′ shown in FIG. 3. In addition, any MLN workstations on the fire workstation side of the Ethernet router 72 may be UL-listed as a fire protective signaling workstation. Workstations that are on the corporate network side of the Ethernet router 52′ need not be UL fire-listed.

In some cases, the fire workstations are located in different buildings within the same campus. In this instance, as illustrated in FIG. 4, each building includes its own fire control network 10a, 10b with its own fire control workstations. Moreover, each network 10a, 10b includes its own Ethernet switch 56a, 56b that is UL listed for fire signaling uses. The two fire alarm segments shown in FIG. 4 are connected between their respective Ethernet switches 56a, 56b. One of the switches, in this case switch 56a, isolated both fire control networks from the non-fire networks. In a preferred embodiment, the link between switches 56a, 56b is established by a fiber optic cable 80.

With respect to FIG. 4, it is noted that non-fire building control workstations such as the workstations 54′ and 66 of FIG. 3 may be connected to either switch 56a or 56b. Similarly, non-fire building control workstations maybe connected to the corporate network, as discussed further above.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

What is claimed is:

1. A data transmission system for a facility comprising:
a first network including;
a number of critical devices disposed within the facility; and
at least one first computer workstation operably coupled to said number of critical devices via said first network;
a second network including at least one second computer workstation; and
an isolating router coupling said first network to said second network and operable to isolate said first network from data transmission traffic in said second network.

2. The data transmission system of claim 1, wherein:
said first network is a fire control network;
said number of critical devices include fire control devices; and
said first computer workstation implements software configured to receive data from and transmit data to said fire control devices.

3. The data transmission system of claim 2, wherein said first network includes a first Ethernet switch that is UL listed for fire protective signaling uses and that is operable to electrically isolate said first network from said isolating router.

4. The data transmission system of claim 1, wherein:
said first network includes a first Ethernet switch that is UL listed for fire protective signaling uses and that is operable to electrically isolate said first network from said isolating router; and
said isolating router is UL listed for information technology equipment.

5. The data transmission system of claim 1, wherein said second network includes a building control network which includes a second Ethernet switch operably coupled to a number of building control devices independent of said operationally critical devices.

6. The data transmission system of claim 5, wherein:
said second network includes a corporate network, independent of said building control network, which includes workstations capable of broadcast transmissions; and
said isolating router is operable to block said broadcast transmissions to said first network.

7. The data transmission system of claim 1, wherein:
said second network includes a corporate network, independent of said first network, which includes workstations capable of broadcast transmissions; and
said isolating router is operable to block said broadcast transmissions to said first network.

8. A data transmission system for use in a facility comprising:
a first fire control Ethernet sub-network including a number of fire control devices and a number of fire safety workstations operably coupled to said fire control devices and operable to implement software for maintaining and controlling said fire control devices;
a second building control Ethernet sub-network including a number of building control devices and a number of building automation workstations operably coupled to said building control devices and operable to implement software for maintaining and controlling said building control devices; and
an isolating router connecting said first sub-network to said second sub-network and operable to isolate said first network from data transmission traffic in said second network.

9. The data transmission system of claim 8, wherein said building automation workstations include a database server workstation and at least one database client workstation.

10. The data transmission system of claim 9, wherein database server workstation is connected within said first sub-network.

11. The data transmission system of claim 10, wherein only workstations connected within said first sub-network are UL listed for fire protective signaling uses.

12. The data transmission system of claim 11, wherein said first sub-network includes a first Ethernet switch that is UL listed for fire protective signaling uses.

13. The data transmission system of claim 12, wherein said isolating router is UL listed for information technology equipment.

14. A data communication system for a facility comprising a first network and a second network connected by a router, the first network including a first plurality of work stations, the second network including a second plurality of work stations, the first plurality of workstations including only building system workstations, the second plurality of work stations including only non-fire safety related building system workstations and non-building system workstations, and wherein the router enables communication between the non-fire related building system workstations and the first plurality of workstations, and the router is operable to disable communication between the non-building system workstations and the first plurality of workstations.

15. The data communication system of claim 1 wherein at least one building system work station is a fire safety system workstation connected to one of a plurality of fire safety system devices.

16. The data communication system of claim 1 wherein the first plurality of workstations includes at least one fire safety system workstation and at least one non-fire building system work station.

17. The data communication system of claim 1 wherein at least one of the non-fire building system workstations is operably connected to heating ventilation and air conditioning system devices.

18. The data communication system of claim 1 wherein the first network includes a switch that is UL listed for fire protective signaling.

19. The data communication system of claim 1 wherein the router is UL listed for information technology equipment.

20. The data communication system of claim 1 wherein the first network comprises at least one Ethernet network and the second network comprises at least one Ethernet network.
